(19) United States
(12) Patent Application Publication
(10) Pub. No.: US 2022/0207365 A1
(43) Pub. Date: Jun. 30, 2022

(54) METHOD FOR CONSTRUCTING AND TRAINING A DETECTOR FOR THE PRESENCE OF ANOMALIES IN A TEMPORAL SIGNAL, ASSOCIATED METHOD AND DEVICES

(71) Applicant: Commissariat à l'énergie atomique et aux énergies alternatives, Paris (FR)

(72) Inventor: Marielle MALFANTE, Grenoble Cedex (FR)

(73) Assignee: Commissariat à l'énergie atomique et aux énergies alternatives, Paris (FR)

(21) Appl. No.: 17/645,337

(22) Filed: Dec. 21, 2021

(30) Foreign Application Priority Data
Dec. 28, 2020 (FR) 20 14188

(51) Int. Cl. G06N 3/08; G06K 9/62; G06K 9/00; G06N 3/04; G07C 5/08

(52) U.S. Cl. CPC G06N 3/08; G06K 9/6256; G06K 9/00523; G07C 5/085; G06K 9/6263; G06N 3/04; G06K 9/00503

(57) ABSTRACT

The present invention describes a method for training a detector (16) of the presence of an anomaly in a signal relating to the environment acquired by a sensor (14) having several signal parts grouping together a set of successive temporal samples, the detector (16) comprising:
a characteristic extraction module (21) for applying an extraction function to the signal, and
a detection module (22) for detecting the presence of an anomaly in a signal part and for applying a detection function to a characteristic representing the signal part, to determine whether an anomaly is present,
the training method comprising:
obtaining the extraction function using self-supervised learning, and
obtaining the detection function using semi-supervised learning.

This patent application claims the benefit of document FR 20 14188 filed on Dec. 28, 2020, which is hereby incorporated by reference.

### FIELD OF THE INVENTION

The present invention relates to a method for constructing and training a detector for the presence of at least one anomaly in a temporal signal. The present invention also relates to an associated detection method, detector and monitoring device.

### BACKGROUND OF THE INVENTION

The field of autonomous vehicles is expanding rapidly. In particular, this development faces problems related to the great diversity of situations confronting the autonomous vehicle.

Among these problems, the detection of abnormal situations is a very important issue insofar as training tests do not make it possible to test the autonomous vehicle in all situations and in that the autonomous vehicle's behavior must guarantee safety to its occupants in all circumstances.

As a corollary of this observation, it is not possible to obtain representative data sets of these situations that enable a complete and reliable evaluation of equipment intended to be embedded in these vehicles.

The solutions proposed to date are the presence of a human being who can intervene at any time, or circulation on dedicated lanes, avoiding the occurrence of certain unforeseen events, which blocks the transition to fully autonomous operation on a large scale.

### SUMMARY OF THE INVENTION

Therefore, there is a need for a method that makes it possible to obtain a detector of the presence of anomalies in a signal, especially a signal from a sensor, which is robust in relation to the detection of still unknown abnormal situations.

To this end, the present description relates to a method for training a detector of a device for monitoring an environment, the detector being a detector of the presence of an anomaly in a signal, the signal being a signal relating to the environment acquired by a sensor, the signal having a plurality of signal parts, each signal part grouping a set of successive temporal samples together, the detector comprising a characteristic extraction module, the extraction module being suitable for applying an extraction function to the signal parts to obtain at least one representative characteristic for each signal part. The detector includes a module for detecting the presence of an anomaly in a signal part, the detection module being suitable for applying a detection function to the at least one representative characteristic of the signal part, to determine whether or not an anomaly is present in the signal part. The training method is implemented by a training module and comprises a step of obtaining the extraction function by using a first learning technique, the first learning technique being self-supervised learning, comprising training a first set of labeled data adapted to a pretext task from a signal recording provided by said sensor, training a convolutional neural network from the labeled data set to obtain a learned neural network suitable for implementing the pretext task, the neural network comprising convolutional layers, an input layer of the neural network implementing a convolutional filter, making a convolution involving at least two distinct temporal samples of a part of the temporal signal, an extraction of one part of the learned neural network, the extracted part comprising the convolutional layers and corresponding to the said extraction function. The training method comprises a step of obtaining the detection function by using a second semi-supervised learning technique, the second semi-supervised learning technique making it possible to define the detection function parameters, in particular, based on a second labeled data set obtained from a signal recording provided by the sensor and considered as normal.

The training method thus makes it possible to carry out training involving little or no human intervention and which can easily be embedded in small and inexpensive electronic systems.

For this, the training method is applied to a 1D signal, that is to say a signal giving a unique value at each sampling instant.

In addition, the neural network inputs of the extraction function correspond to or are fed by a series of successive samples of the physical quantity measured by the sensor.

This ensures good compactness of the solution.

According to particular embodiments, the training method has one or more of the following characteristics, taken alone or in any technically possible combination:
in the step of obtaining the extraction function, the convolutional neural network also comprises fully connected layers, the extracted part being the convolutional layers of the learned neural network;
the device further comprises a signal classification module, the classification module having been learned using a data set, the second learning technique used in the step of obtaining the detection function using the same data set considering the data set as corresponding to anomaly-free data.

The description also describes a method for detecting the presence of an anomaly in a signal, the method being implemented by a detector of a device for monitoring an environment, the signal being a signal relating to the environment acquired by a sensor, the signal having several signal parts, each signal part comprising a set of successive temporal samples, the method being implemented by a detector that is a detector of the presence of a signal anomaly, the detector comprising a characteristic extraction module and a detection module, the detection method comprising a characteristic extraction step, the extraction step being implemented by the extraction module and comprising applying an extraction function on each signal part to obtain at least one representative characteristic for each signal part, the extraction module comprising a neural network including convolutional layers, with an input layer of the neural network implementing a convolutional filter, making a convolution involving at least two distinct temporal samples of a part of the temporal signal. The method includes a step of detecting the presence of an anomaly in a signal part, the detection step being implemented by the detection module and comprising applying a detection function to the at least one characteristic representing the signal part, to determine whether or not an anomaly is present in the signal part, the detector having been trained by a training method, as previously described.

According to particular embodiments, the detection method has one or more of the following characteristics, taken alone or in any technically possible combination:
the device further comprises a warning module, the detection method further comprising a step of warning that the detection module has detected the presence of an anomaly in a signal part;
the device further comprises a memory suitable for storing the signal parts for which the detection module has detected the presence of an anomaly, the method further comprising a further step of obtaining the detection function using a data set comprising the stored signal parts;
the training module is part of the device.

The description also describes a detector of a device for monitoring an environment, the detector being a detector of the presence of an anomaly in a signal, the signal being a signal relating to the environment acquired by a sensor, the signal having a plurality of signal parts, each signal part comprising a set of successive temporal samples, the detector comprising a characteristic extraction module the extraction module being suitable for applying an extraction function to the signal parts in order to obtain at least one representative characteristic for each signal part, the extraction module comprising a neural network including convolutional layers, with an input layer of the neural network implementing a convolutional filter, carrying out a convolution involving at least two distinct temporal samples of a part of the temporal signal. The detector comprises a module for detecting the presence of an anomaly in a signal part, the detection module being suitable for applying a detection function to the at least one characteristic representing the signal part to determine whether or not an anomaly is present in the signal part, the detector having been trained by a training method as previously described.

The description also relates to a device for monitoring an environment, the device comprising a sensor suitable for acquiring a signal relating to the environment and a detector of the presence of an anomaly in the signal acquired by the sensor, the detector as previously described.

### BRIEF DESCRIPTION OF THE DRAWINGS

Further characteristics and advantages of the invention will become apparent from the following description of embodiments of the invention, given by way of example only and with reference to the drawings, which are:

FIG. 1, a schematic illustration of an example system comprising a detector of the presence of anomalies in a signal,

FIG. 2, a schematic illustration of the operation of a part of the system of FIG. 1,

FIG. 3, a flowchart of an example operation of the system of FIG. 1,

FIG. 4, a schematic representation of a part of the system of FIG. 1 at certain stages of operation shown in FIG. 3, and

FIG. 5, a schematic representation of another example system comprising a detector of the presence of anomalies in a signal.

### DETAILED DESCRIPTION OF THE PREFERRED EMBODIMENTS

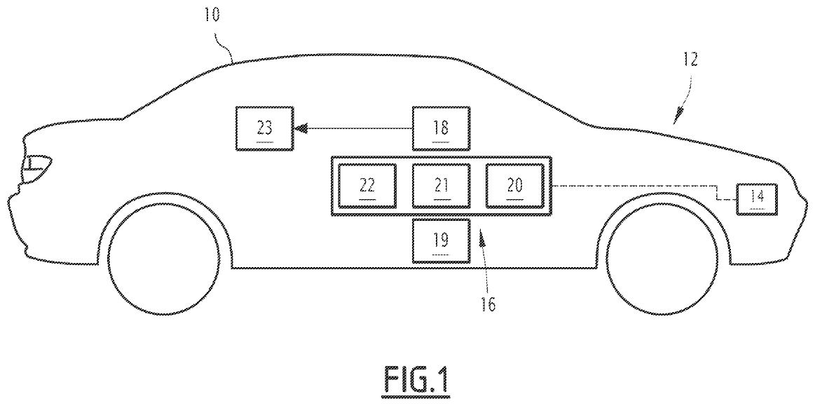

A system 10 is shown in FIG. 1.

In this case, the system 10 is a vehicle, more specifically a car.

The system 10 includes a device 12 for monitoring the environment of the system 10.

As the name implies, the device 12 is suitable for monitoring the environment.

In the proposed example, the device 12 comprises a sensor 14, a detector 16, a warning module 18 and a training module 19.

The sensor 14 is suitable for acquiring a signal relating to the environment.

As an illustration for the described example, the sensor 14 is a lidar or radar and the physical quantity is the distance of an obstacle.

Other examples are possible, such as an acoustic sensor or a temperature sensor or a vibration sensor.

In this case, the sensor 14 acquires a signal that gives the evolution of a physical quantity over time and delivers this signal to the detector 16.

The signal delivered is therefore a temporal signal or a temporal series that has several signal parts.

The signal is thus a one-dimensional signal, that is to say, it gives the temporal evolution of a single value.

The detector 16 is a detector of the presence of an anomaly in the signal acquired by the sensor 14, and more specifically in part of it.

An anomaly is data that deviates significantly from the usual data. The terms deviation or outlier are also used.

Traditionally, anomalies are divided into three distinct categories, namely point, contextual and collective anomalies.

Point anomalies correspond to the case of a point that moves away from the others, usually without a particular interpretation. These anomalies are sometimes designated as “point anomalies”.

Contextual anomalies are anomalies that depend on the context and in particular on the expected behavior in such a context. Such anomalies are sometimes referred to as “contextual anomalies”. It may be noted that the “conditional anomaly” term is sometimes used to designate this type of anomaly.

Collective anomalies consist of data that appears normal taken individually but, in combination, form a group (a pattern) that is aberrant. Such anomalies are sometimes designated as “collective anomalies”.

The presence of an anomaly may be due to a plurality of very different causes.

For example, the anomaly may be a sign of an intrusion, an attack, a sensor failure or an unknown situation.

The detector 16 includes an input module 20, an extraction module 21 and a detection module 22.

The input module 20 is suitable for receiving the signal coming from the sensor 14 and for conducting the received signal in a suitable form to be injected into the input of the extraction module 21, i.e. the input module 20 determines the parts of the signal that will then be sent to the extraction module 21.

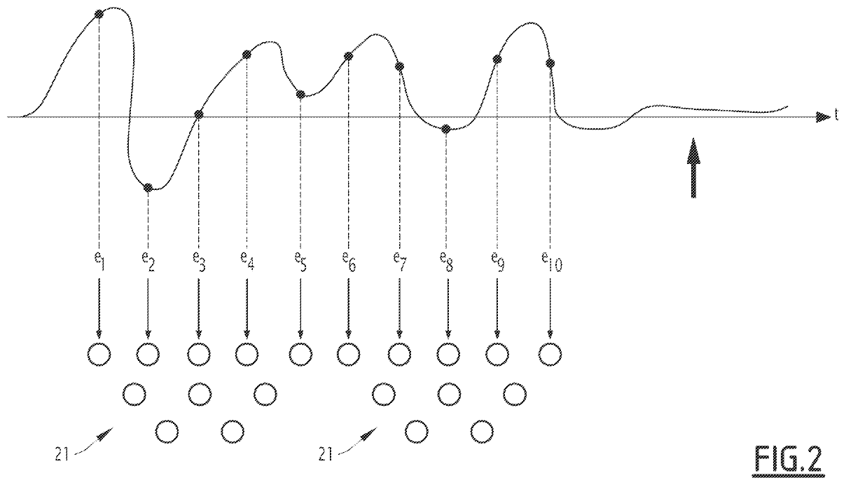

According to the described example, the signal is assumed to be an analog signal, as shown in FIG. 2.

The extraction module 21 comprises a sampler, a storage unit and a training unit.

The sampler is suitable for sampling the received signal at a sampling frequency, to obtain temporal samples.

Each sample at a sampling instant thus represents a unique value.

The samples can be digitized or stored in analog form according to the embodiment of the following module.

In the proposed example, the samples are assigned an index.

In FIG. 2, ten samples are shown.

The storage unit is suitable for storing samples.

Here, the storage unit is temporary, so that the number of stored samples is relatively limited.

In the following, it will be seen that it can be advantageous if the number of stored samples is greater than the number of samples in a part.

The training unit is suitable for forming the signal parts adapted for the extraction module 21.

The extraction module 21 imposes a constraint that each signal part has the same number of samples, because the extraction module 21 takes a fixed number of samples as input.

As an illustration, the extraction module 21 is assumed to handle a set of five temporal samples as input.

According to one simple embodiment, the training unit uses a temporal window that has slide in, by selecting the appropriate number of temporal samples.

With the same example of five temporal samples, the size of the temporal window is five samples, and the training unit will prepare a first part corresponding to samples 1 to 5 and then a second part corresponding to samples 6 to 10, and so on.

In a variant, the parts can overlap, with the training unit preparing a first part corresponding to samples 1 to 5, for example, then a second part corresponding to samples 2 to 6, and so on.

It should be noted that each part prepared by the training unit is intended to provide a sequence of consecutive samples showing a continuous portion of the temporal signal. Depending on the sampling rate, the temporal signal portion shown by a training unit output (a “part”) may in practice have a different temporal duration. Thus, if the sampling frequency can vary by as much as two times, the corresponding signal portion duration can also vary by as much as two times. The signal portion duration shown by a signal part formed of samples is hereafter referred to as the duration Dp of the signal part.

In one possible embodiment, in which it is desired to observe signal parts of different sizes and therefore different durations Dp, the sampling frequency of the training unit can be varied. To do so, a sampler operating at the desired maximum frequency may be available, and the sampler outputs may be subsampled, to emulate a lower frequency sampling. In this case, the training unit selects non-consecutive samples, training part of the signal from the even samples, for example.

The first signal part will then group together samples 2, 4, 6, 8 and 10.

In addition, the training unit may include a selection unit to transmit a signal part to the extraction module 21 only if it meets a predefined criterion.

As an example, if the part corresponds to a time when the sensor 14 does not register any signal, it is not necessary to determine whether an anomaly is present or not. An example of such a part is pointed to by a double arrow in FIG. 2.

For this, the selection unit can apply a criterion that compares the signal amplitude to a threshold over a period of time corresponding to a signal portion, in particular over the period of time Dp corresponding to a potential part of the signal that one would subsequently like to transmit to the extraction module 21.

The input module 20 thus makes it possible to obtain a set of signal parts with identical or possibly different durations Dp.

This set of signal parts corresponds to an unlabeled data set.

The extraction module 21 is a characteristic extraction module.

According to the described example, the extraction module 21 is suitable for applying a first function to the signal, called the extraction function, to obtain at least one representative characteristic for a signal part.

More precisely, in the described example, the extraction module 21 will receive a first signal part corresponding to samples 1 to 5 as input, to apply the extraction function to them and to deduce therefrom at least one characteristic representing the first part.

Then, the extraction module 21 will receive a second signal part corresponding to samples 6 to 10 as input, to apply the extraction function to them and to deduce therefrom at least one characteristic representing the second part. And so on, for other signal parts transmitted by the training module to the extraction module 21.

Examples of characteristics are provided later.

The detection module 22 is a module for detecting the presence of an anomaly in a signal part.

The detection module 22 is suitable for applying a second function, called the detection function, on the at least one extracted characteristic, to determine whether or not an anomaly is present in the signal part.

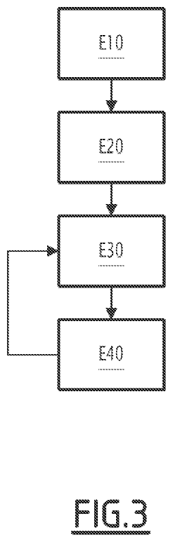

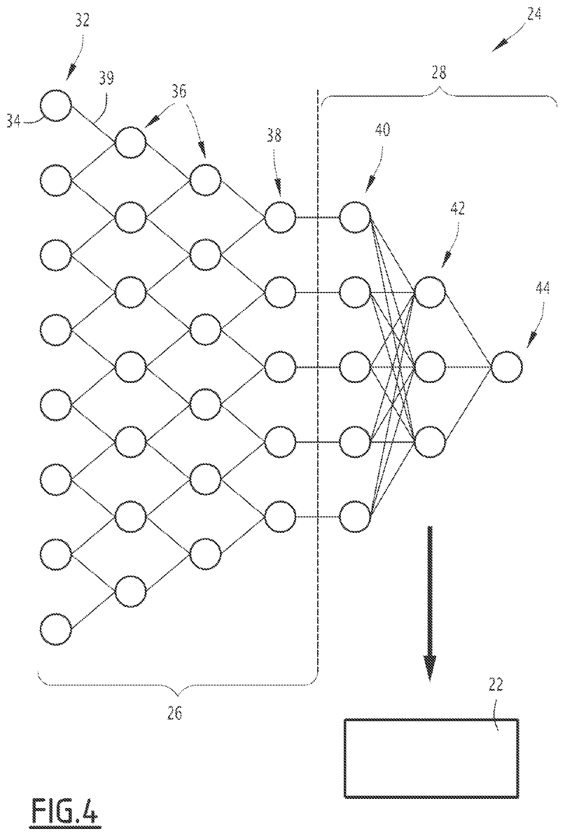

The nature of the two functions as well as the manner in which the training module 19 obtains them will be described later with reference to FIGS. 3 and 4.

The warning module 18 is suitable for warning that the detection module 22 has detected the presence of an anomaly in a signal part.

For example, the warning module 18 is a visual, audible, haptic or other, possibly mixed human/machine interface.

In a variant or additionally, the warning module 18 is a device that emits a warning, in the form of an electronic signal, for example, to a general control device 23 of the vehicle 10.

The training module 19 is suitable for training the sensor 16.

This means that the training module 19 is suitable for training the extraction and detection functions to obtain the most appropriate ones, depending on the data available to the training module 19.

In particular, when the training module 19 will be operating prior to the detector 16 being turned on, the training module 19 is an initialization module.

In the example described, the training module 19 is also capable of training the detector 16 based on data obtained during operation of the detector 16. The training module 19 is then an adjustment module.

The operation of the system 10 is now described with reference to the flowchart in FIG. 3, which shows a succession of steps that can be implemented to enable proper detection of anomalies present in a temporal series.

In a first step E10, the training module 19 obtains the first function, i.e. the extraction function, by applying a first learning technique.

The extraction function is part of a neural network 24, an example of which is shown schematically in FIG. 4.

The neural network 24 is a particular neural network, in this case a convolutional neural network that could be described as a temporal type.

In what follows, in describing FIG. 4, each of the concepts of “neural network,” “convolutional neural network,” and “temporal type” are explained in turn.

The neural network 24 includes two sets of layers, 26 and 28, that train two neural subnetworks.

Each set, 26 or 28, includes an ordered succession of layers 32 of neurons 34, each of which takes its inputs from the outputs of the preceding layer 32.

More specifically, each layer 32 comprises neurons 34 that take their inputs from the outputs of the neurons 34 of the previous layer 32.

In a variant, more complex neural network structures can be envisioned with a layer that can be connected to a layer farther away than the immediately preceding layer.

Also associated with each neuron 34 is an operation, i.e. a type of processing to be performed by said neuron 34 within the corresponding processing layer.

In the case of FIG. 4, the first set 26 comprises hidden layers of neurons 36 (two are visible in FIG. 4, but this number is not limiting). This means that the first set has an input layer followed by the hidden neural layers 36, with the set followed by an output layer 38.

Each layer 32 is connected by a plurality of synapses 39. A synaptic weight is associated with each synapse 39. This is often a real number that takes on both positive and negative values. In some cases, the synaptic weight is a complex number.

Each neuron 34 is suitable for performing a weighted sum of the value(s) received from the neurons 34 of the previous layer 32, with each value then multiplied by the respective synaptic weight, then an activation function, typically a non-linear function, applied to said weighted sum and the value resulting from application of the activation function delivered to the neurons 34 of the next layer 32. The activation function makes it possible to introduce non-linearity in the processing performed by each neuron 34. The sigmoid function, the hyperbolic tangent function and the Heaviside function are examples of activation functions.

As an optional addition, each neuron 34 is also capable of further applying a multiplication factor, also called a bias, to the activation function output, and the value delivered to the neurons 34 of the next layer 32 is then the product of the bias value and the output value of the activation function.

Similarly, the second subset 28 has an input layer 40 connected to a hidden neuron layer 42, which in turn is connected to an output layer 44.

The elements of the previous description provide a better understand of the neural network notion.

It is now necessary to explain a convolutional neural network.

A network of convolutional neurons is also sometimes referred to as a convolutional neural network or by the acronym CNN, which refers to the English name of “convolutional neural networks”.

In a convolutional neural network, each neuron of the same layer has exactly the same connection pattern as its neighboring neurons, but at different input positions. The connection pattern is called a convolution kernel or, more commonly, “kernel”, referring to the corresponding English name.

Here, the first set 26 gathers the layers of neurons performing a convolution operation, also called convolutional layers (corresponding to the signal filtering operation by the kernel).

The convolutional layers make it possible to obtain a representation of the signal parts that is the most convenient possible for the function using this representation, in particular for the second set 28, which is used to conduct a pretext task as explained below, or for the detection module 22, also described below.

In a pictorial and simplified manner, likening a representation to a space, the first set 26 performs a projection of the signal parts into that representation space. An example of a characteristic associated to a signal part that the first set 26 is suitable for finding is thus the equivalent of a coordinate of the part in that representation space.

In this example, the second set 28 gathers fully connected layers.

A fully connected layer of neurons 32 is one in which the neurons in the layer are each connected to all the neurons in the previous layer.

Such a layer 32 is most commonly referred to as a “fully connected” layer and sometimes referred to as a “dense layer”.

The second set 28 is the set that will make it possible to perform a pretext task from the parts shown according to the above representation.

Such a neural network 24 may include other layers that are not described in the following.

For example, the neural network 24 includes one or more pooling layers (e.g. averaging or “max pooling”), a correction layer (more often referred to as ReLu, referring to the English name of “rectified linear unit”), or a loss layer (often referred to as a “softmax” layer, since it uses a softmax or normalized exponential function).

In addition, it has been stated that the convolution neural network is temporal in nature.

This means that the neural network 24 has at least one kernel, or convolutional filter, that performs a convolution involving at least two distinct temporal samples of a part of the temporal signal.

Such a “temporal” convolution is implemented at least at the input of the neural network 24, i.e. at the input of the first set 26.

Having described the neural network 24 structurally, how the neural network 24 is learned is now described.

In the example described, the training module 19 uses a self-supervised learning technique as its first learning technique.

Self-supervised learning is more often referred to as SSL.

Such learning is machine-supervised learning, i.e. learning during which it is possible to adjust the neural network, in particular the values of its synaptic weights, by learning iteratively, using a cost function based on the comparison of the difference between the neural network output and the expected output. Supervised learning is based on a training data set, so-called labeled data, defining a set of input/output pairs corresponding to expected data for a given input for each pair.

However, self-supervised learning is specific in the sense that it is implemented from a known initial data set that does not correspond to a labeled data set defined above and that does not make it possible to implement supervised learning directly. Self-supervised learning comprises an initial step of automatically creating a labeled data set from an initial data set corresponding to one or more signal extracts from the sensor considered “normal”, i.e. without anomalies, and knowing a pretext task implemented in a second step following this initial step of creating a labeled data set.

In this case, the training module 19 uses a predefined task that is unrelated to the task of determining the presence of anomalies. The predefined task only serves to enable the training of the free parameters of the neural network defined through the training operation. In this sense, the predefined task can be referred to as a pretext task, a name that will be used in what follows.

In an example embodiment, the pretext task used by the training module 19 is a task of predicting the signal value at a given time based on a predefined number of previous values.

Thus, if we consider the case where our neural network 24 would have 5 inputs on its input layer, for example, the proposed pretext task consists of providing five consecutive sample values of the sensor signal 14 as input to the neural network 24 and predicting the sixth or next sample value of the sensor signal 14 on an output of the output layer 44. This input data (the 5 values) and the expected output result (the sixth value) thus constitute a labeled data pair.

The set of the five previous values of the sensor signal 14 and the sixth value form first training data set data, then used in the implementation of the supervised learning operation aiming at defining the free parameters of the neural network 24 when it is designed to implement the pretext task.

In such an embodiment, it is of interest that the temporary storage unit of the input module 20 stores more temporal samples than the number of samples of a signal part as defined above and ultimately used in a use of the detector 16 in an operating condition. Thus, if the storage unit of the module 20 comprises a hundred or so storage elements, for example, allowing the storage of a hundred or so samples of a signal extract from the sensor, then it is possible to produce numerous labeled data pairs according to the process described above. It is thus possible to create a first training data set comprising a plurality of labeled input/output pairs that can be used for this first supervised learning based on a pretext task. In a variant, the training module 19 uses, as a pretext task, filling in a set of missing values in the temporal signals of the sensor 14.

For example, the task would be to predict the third time temporal knowing the first, second, fourth, fifth and sixth temporal sample.

In a variant, a pretext task of the input data reconstruction type can be used.

For this purpose, the complete neural network 24 is in an auto-encoder form (more often referred to as an “auto-encoder”). Thus, in contrast to what is shown in FIG. 4, such a neural network 24 would have a number of network outputs identical to the number of network inputs.

The training module 19 then implements training a neural network 24 from a labeled data set which is in easily constructed this particular case, insofar as the expected output values are identical for input values.

In other words, the training module 19 adjusts the parameters of the neural network 24 so that an inference through the neural network 24 makes it possible to find outputs as close as possible to the input values.

The training module 19 thus obtains a first network 24 learned according to this first self-supervised learning.

The training module 19 then extracts the convolutional layers of the first learned neural network 24 to obtain the extraction function.

The extraction function is thus the extraction neural network corresponding to the first set 26, i.e. the set of convolutional layers of the learned neural network 24.

Such an operation amounts to neglecting the fully connected layers and more specifically to considering that the set of convolutional layers makes it possible to obtain a temporal data (here, the sensor signal) representation model as an output that is reliable and sufficient to be reused later.

In the second step E20, the training module 19 learns the second function, i.e. the detection function.

More precisely, the training module 19 will adjust the parameters of the anomaly detection function.

This is schematically shown in FIG. 4 by an arrow indicating that the second set 28 is replaced by the detection module 22, and more specifically by the detection function.

To accomplish this, the training module 19 uses a second learning technique that differs from the first learning technique.

The second learning technique is a semi-supervised learning technique of the first neural network set and the anomaly detection function that forms a classifier, in practice a one-class classifier indicating whether or not there is an anomaly present in the considered signal part.

The anomaly detection function can be implemented by various models. For example, the one-class support vector machine (OC-SVM) algorithm or support vector data description (SVDD) algorithm, or the isolation forest algorithm can be used. It is also possible to use a detection function built on a neural network basis.

It is necessary to specify here which parameters are used for the training. In this case, the adjustable parameters of the anomaly detection function are learned so that a computation (or inference, in the case of a neural network) through the classifier makes it possible to find the expected output value, either “anomaly” or “normal” for a given input value that is known to be normal or abnormal.

It should be noted that during this second step E20, the learned neural network, and in particular the conserved part, namely the neural network 26, remains unchanged. In the particular case where the detection function 22 is implemented by a neural network, it may be possible to authorize slight modifications of the parameters of the first neural network 26, in particular of its last layers, within a predefined range of variation of the synapse values in order to carry out fine tuning.

According to the example described, it is assumed that no abnormal data is available.

The learning technique is then semi-supervised in the sense that the training module 19 will only provide normal or nominal data as input to the classifier and not abnormal data.

Of course, if abnormal data were known, it would be possible to implement supervised learning using this abnormal data, and this would in all likelihood lead to better results.

However, in this case, the anomalous data is data that is not part of the training data set used by training module 19.

In such a situation, where there is only one class (normal here) in the training data set, the term one-class classifier is often used to refer to the classifier.

More generally, semi-supervised learning is learning based on a training data set in which a class (in this case abnormal data) is not present.

During this second learning operation, in step E20, a calculation is performed several times through the detector 22 to define the free parameters of the detection model. The detector 22 is composed of the first learned neural network 26, whose outputs are linked to inputs of the detection model. An elementary operation of this second learning consists in placing a signal part considered as normal in the input of the first learned neural network 26, calculating the outputs of the corresponding first neural network 26, then injecting them in the detection model with these current free parameter values. The output obtained at the detection model output is deemed normal or abnormal by the detection model, or, in a more refined way, an evaluation, probabilistic for example, of the normality of the considered signal part is obtained at the detection model output. Depending on the difference between the expected result, corresponding to “fully normal” and the degree of normality obtained, the learning mechanism retroacts on the free parameters of the detection model in order to induce a change in these parameter values that enable the detection model to consider such an input data as normal. This operation is repeated for different signal parts considered normal. The signal parts considered normal, constituting a second labeled data database used in this second learning, can be constituted from a sensor signal recording, which may be the same as that used to prepare the labeled data first set, for example. It should be noted, however, that the first and second labeled data sets used for the first and second learning operations are a priori different in that the models or networks learned are different.

At the end of the first two steps E10 and E20, a detector 16 is thus obtained comprising the extraction function 21, corresponding to the first learned network 26, followed by the detection model 22.

The two steps E10 and E20 together can be seen as an initial learning phase of the detector 16.

The third step E30 corresponds to the use of the detector 16 thus learned.

In operation, the detector 16 thus receives signal parts from the sensor 14 and determines whether these parts are normal or not.

The detector 16 performs this task automatically.

To do this, the detector 16 uses artificial intelligence techniques based on two distinct components: a data representation model determined by the extraction module 21 and a data analysis model determined by the detection module 22.

The use of a self-supervised learning technique to define the extraction neural network makes it possible to obtain a very relevant representation model for detection of the presence of anomalies by means of the detection module 22 based on the representation model outputs, in the form of a convolutional neural network 26.

It should be noted that the representation model may also be relevant for other applications, so that it is possible that the extraction module 21 is simultaneously used to obtain other results, typically by using another neural network, taking the outputs of the extraction module 21 as input.

Moreover, such a representation model is obtained with a significant relaxation of constraints on the training set. Indeed, no manual labeling is required.

More precisely, starting from an unlabeled data set, the method proposes training a first labeled data set for a pretext task, to learn a part of the detector 16, and afterwards learn the other part, based on a second labeled data set, the labeled data sets being made automatically from a sensor signal recording considered by a human as reliable. Note that the first labeled data set can possibly be constructed from a sensor signal recording not validated by a human, unlike the second data set.

Since the representation model is of good quality, the anomaly detection device is robust with respect to detecting unknown abnormal situations.

The parts considered abnormal can be stored in a storage unit not shown in FIG. 1 for further exploitation.

In the proposed example, the stored data can be used to improve the anomaly detection device.

In the fourth step E40, the training module 19 uses the data stored in the storage unit to re-train the detection function.

In the described example, the training module 19 performs the training using supervised learning using the abnormal data obtained from the third step E30.

Due to the use of new data, the detection function can be made more accurate.

The new detection function is then used in the third step E30.

Again, during operation, abnormal data will be stored and a new learning can be performed by the training module 19 in the fourth step E40.

The detection function thus learned can then be used in the third step E30 and so on.

The fourth step E40 thus corresponds to an incremental learning of the detection function and thus of the detection device 12.

The fourth step E40 can be initiated by the general control device 23 of the vehicle 10.

Such learning makes it possible for the sensor 16 to be best adapted to the available data.

This makes the detection device 12 particularly suitable for all monitoring applications, not just in an in-vehicle system.

More specifically, the detection device 12 is suitable for little or poorly known environments, such as monitoring geographical areas (for example, sparsely populated areas such as a glacier, forests, rivers, oceans, coastal areas, applications for populated areas also being possible, in particular the detection of cries in a crowd), monitoring constructions (buildings, bridges or wind turbines), monitoring geological risks (earthquakes or volcanoes) or even the human body. For this last point, using the connected bracelet system to determine the occurrence of an epileptic attack, a heart attack or an allergic attack can be envisaged.

In addition, the detection device 12 may be physically implemented with few constraints.

For example, in a dedicated integrated circuit-based implementation, the sensor 16 is for example implemented as an application specific integrated circuit (ASIC).

In a variant, the extraction module 21 and the detection module 22 are each made in the form of a programmable logic component, such as a field programmable gate array (FPGA).

According to another example, when the detection device 12 is implemented by a calculator or other equivalent computing unit, the calculator may execute a program corresponding to one or more software programs, i.e. in the form of a computer program. Such executable programs enabling implementation of the above method may be stored on a computer-readable medium, not shown. The computer-readable medium is a medium capable of storing electronic instructions and of being coupled to a bus of a computer system, for example. As an example, the readable medium is an optical disk, a magneto-optical disk, a ROM memory, a RAM memory, any type of non-volatile memory (e.g. EPROM, EEPROM, FLASH, NVRAM), a magnetic card or an optical card. A computer program with software instructions is stored on the readable medium.

Because it is possible to envisage implementations of small size and relatively low power consumption, such a detection device 12 can be used in embedded systems, particularly as part of an intelligent sensor. In this case, the method according to the invention can be fully or partially implemented by means of dedicated hardware circuits. On such embedded systems, a dedicated circuit may be used in particular for the implementing neural network type functions. Moreover, the same generic neural computing circuit can be used for the networks 26, 28 and also to realize the detection module 22 when this is done from a neural network. Such generic neural computation circuits are generally coupled to memories storing the various neural network parameters. The detector 16 can thus include a micro-processor to launch different operations of the above-mentioned method by calling on dedicated hardware elements. Among these dedicated hardware elements, in addition to the previously mentioned neural computing elements, there may be elements dedicated to processing the signal coming from the sensor, for its sampling, analog/digital conversion or memorization of a temporal part in a buffer memory. Moreover, the microprocessor may be connected to other hardware components to perform the above-mentioned warning functions.

According to a variant, making it possible to have a very compact embedded system, the implementation of the steps E10 and E20 of learning of the method can be carried out on a remote processor, and only the result of the learning is stored in the embedded system memory. The on-board system then comprises only the hardware elements necessary to implement the detection step E30.

In this variant, the on-board system may possibly have a memory for storing the parts of the temporal signal from the sensor that led to the detection of an anomaly. Such storage of the signal related to the anomaly then makes it possible to implement step E40 with the help of a remote processor by transmitting the abnormal data to it, then by receiving, in return, a possible update of the parameters of the detection model 22 and possibly of the neural network 26.

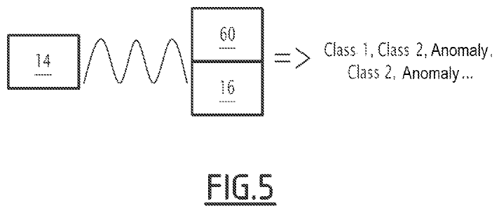

According to another example application shown schematically in FIG. 5, the device 12 may further include a signal classification module 60, the classification module 60 having been learned using a suitable data set.

The classification module 60 is, learned using a supervised learning technique, for example.

The data set may also be used for training the detection function by considering the data set as corresponding to anomaly-free data.

The classification module 60 outputs according to the proposed example classes 1 or 2 based on the input.

In such an example, the detector 16 serves to supplement the information of the classification module 60 by adding a class corresponding to anomalous data if the classification module 60 is not able to detect the presence of an anomaly.

It should also be noted that the learning in the described embodiment is done locally via the training module 19, but it is possible to perform the learning offline with a training module that would be a generic computer, for example.

In such a case, the training module 19 can also be used only for initialization of the detector 16 and not perform any incremental learning of the detector 16. In a variant, the remote training module 19 may be called on for incremental learning as well.

In either case, the detection device 12 can detect signal anomalies robustly.

1. A method for training a detector of an environmental monitoring device, the device comprising a training module, the detector being a detector of the presence of an anomaly in a signal, the signal being a signal giving the time evolution of physical quantity and relating to the environment acquired by a sensor, the signal being a temporal series and having a plurality of signal parts, each signal part comprising a set of successive temporal samples of the same physical quantity, the detector comprising:
a characteristic extraction module, the extraction module being suitable for applying an extraction function to the signal parts, to obtain at least one representative characteristic for each signal part, and
a detection module for detecting the presence of an anomaly in a signal part, the detection module being suitable for applying a detection function to the at least one representative characteristic of the signal part, to determine whether an anomaly is present in the signal part,
the method for training being implemented by the training module comprising:
a step of obtaining the extraction function by using a first learning technique, the first learning technique being self-supervised learning comprising:
training a first set of labeled data adapted to a pretext task, the first set of labeled data being a set of signal parts obtained from a signal recording of the same physical value provided by said sensor,
training a convolutional neural network from the labeled data set to obtain a trained neural network suitable for implementing the pretext task, the neural network comprising convolutional layers, with an input layer of the neural network implementing a convolutional filter making a convolution involving at least two distinct temporal samples of a part of the temporal signal,
an extraction of a part of the learned neural network, the extracted part comprising the convolutional layers and corresponding to said extraction function, and
a step of obtaining the detection function by using a second semi-supervised learning technique, making it possible to define the detection function parameters from a second labeled data set obtained from a signal recording supplied by the sensor and considered as normal.

2. The training method according to claim 1, wherein in the step of obtaining the extraction function, the convolutional neural network also comprises fully connected layers, the extracted part being the convolutional layers of the learned neural network.

3. The training method according to claim 1, wherein the device further comprises a signal classification module, the classification module having been learned using a data set, with the second learning technique used in the step of obtaining the detection function using the same data set considering the data set as corresponding to anomaly-free data.

4. A method for detecting the presence of an anomaly in a signal, the method being implemented by a detector of a device for monitoring an environment, the signal being a signal relating to the environment acquired by a sensor, the signal having several signal parts, each signal part comprising a set of successive temporal samples, the method being implemented by a detector, being a detector of the presence of an anomaly in a signal, the detector comprising a characteristic extraction module and a detection module, the detection method comprising:
a characteristic extraction step, the extraction step being implemented by the extraction module and comprising applying an extraction function on each signal part to obtain at least one representative characteristic for each signal part, the extraction module comprising a neural network including convolutional layers, with an input layer of the neural network implementing a convolutional filter making a convolution involving at least two distinct temporal samples of a part of the temporal signal; and
a step of detecting the presence of an anomaly in a signal part, the step of detecting being implemented by the detection module and comprising applying a detection function to the at least one characteristic representing the signal part, to determine whether or not an anomaly is present in the signal part the detector having been trained by a training method according to claim 1.

5. The detection method according to claim 4, wherein the device further comprises a warning module, the detection method further comprising a step of warning that the detection module has detected the presence of an anomaly in a signal part.

6. The detection method according to claim 4, wherein the device further comprises a memory suitable for storing the signal parts for which the detection module (22) has detected the presence of an anomaly, the method further comprising a further step of obtaining the detection function using a data set comprising the stored signal parts.

7. The detection method according to claim 6, wherein the training module is part of the device.

8. A detector of a device for monitoring an environment, the detector being a detector of the presence of an anomaly in a signal, the signal being a signal relating to the environment acquired by a sensor, the signal having a plurality of signal parts, each signal part comprising a set of successive temporal samples, the detector comprising:
a characteristic extraction module, the extraction module being suitable for applying an extraction function to the signal parts to obtain at least one representative characteristic for each signal part, the extraction module comprising a neural network including convolutional layers, an input layer of the neural network, implementing a convolutional filter making a convolution involving at least two distinct temporal samples of a part of the temporal signal, and
a detection module for detecting the presence of an anomaly in a signal part, the detection module being suitable for applying a detection function to the at least one characteristic representing the signal part, to determine whether or not an anomaly is present in the signal part
the detector having been trained by a training method according to claim 1.

9. A device for monitoring an environment, the device comprising:
a sensor suitable for acquiring a signal relating to the environment, and
a detector of the presence of an anomaly in the signal acquired by the sensor, the detector being according to claim 8.
